(19) United States
(12) Patent Application Publication
(10) Pub. No.: US 2006/0203380 A1
(43) Pub. Date: Sep. 14, 2006

(54) Perpendicular magnetic disk apparatus

(75) Inventor: Tomoko Taguchi, Kunitachi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/372,276

(22) Filed: Mar. 10, 2006

(30) Foreign Application Priority Data
Mar. 11, 2005 (JP) 2005-069891

(51) Int. Cl. G11B 5/127

(52) U.S. Cl. 360/125

(57) ABSTRACT

According to one embodiment, a perpendicular magnetic disk apparatus has a perpendicular recording medium including a soft underlayer and a perpendicular recording layer, and a write head including a main pole, a return yoke and an exciting coil, in which a product of a magnetostriction constant λ [E-6] of the main pole and a stress S [MPa] acting on the main pole, and a coercivity Hc [Oe] of the medium meet the following formula:
λ×S>30,000,000/Hc

### CROSS-REFERENCE TO RELATED APPLICATIONS

This application is based upon and claims the benefit of priority from Japanese Patent Application No. 2005-069891, filed Mar. 11, 2005, the entire contents of which are incorporated herein by reference.

### BACKGROUND

1. Field

One embodiment of the present invention relates to a perpendicular magnetic disk apparatus capable of suppressing degradation of recorded data.

2. Description of the Related Art

Magnetic disk apparatuses are perpetually demanded to improve recording densities, and thus the recording scheme is being shifted to the perpendicular recording system. Also in the perpendicular magnetic disk apparatus, the bit size carrying information on the recording medium is inevitably reduced in accordance with the increase in recording density. Consequently, there is a tendency that erroneous erasure of data recorded on the medium may easily occur, leading to degradation of recording stability. One factor of erroneous erasure of data recorded on the medium is a perpendicular magnetic field that is generated based on magnetization remaining on the main pole after recording operation.

Conventionally, there has been proposed a perpendicular magnetic head whose residual magnetization on the main pole can be reduced (Jpn. Pat. Appln. KOKAI Publication No. 2004-86961). This perpendicular magnetic head includes a write pole, a supplemental pole and a coil. The write pole includes a main pole and a yoke portion having a greater width than the main pole in the cross-track direction. The magnetostriction constant of the main pole and the magnetostriction constant of the yoke portion have positive and negative signs, respectively.

According to research by the present inventor, however, it has been found that the problem of erroneous erasure of data cannot be solved by merely controlling the magnetostriction constants of the main pole and yoke portion.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not limit the scope of the invention.

FIG. 1 is a perspective view of a perpendicular magnetic disk apparatus according to an embodiment of the present invention;

FIG. 2 is a perspective view of a perpendicular magnetic disk apparatus according to another embodiment of the invention;

FIG. 3 is a graph showing the relationship between a coercivity Hc of a medium and an occurrence rate of recording instability when magnetic heads each including a main pole formed of different materials are used; and

FIG. 4 is a graph showing lower-limit conditions under which the occurrence rate of recording instability becomes zero in a coordinate system of the coercivity Hc of the medium and the product of λ×S.

### DETAILED DESCRIPTION

Various embodiments according to the invention will be described hereinafter with reference to the accompanying drawings. In general, according to one embodiment of the invention, there is provided a perpendicular magnetic disk apparatus comprising: a perpendicular recording medium including a soft underlayer and a perpendicular recording layer; and a write head including a main pole, a return yoke and an exciting coil, wherein a product of a magnetostriction constant λ [E-6] of the main pole and a stress S [MPa] acting on the main pole, and a coercivity Hc [Oe] of the medium meet the following formula:
λ×S>30,000,000/Hc.

Whether erroneous erasure of data recorded on the medium occurs or not, depends on the balance between magnitude of a perpendicular magnetic field by magnetization remaining on the main pole after recording operation and stability of the recorded state in the medium. The inventor has found that, in order to solve the problem of erroneous erasure, it is necessary to take the magnetostriction constant of the main pole, the stress acting on the main pole, and the coercivity of the medium into account. To be more specific, it is necessary that a product of a magnetostriction constant λ [E-6] of the main pole and a stress S [MPa] acting on the main pole, and a coercivity Hc [Oe] of the medium meet the following formula (1):
λ×S>30,000,000/Hc (1).

The stress S is induced when the main pole is formed, and it uniformly acts in the film surface. The product of λ and S is electrostriction energy. In a perpendicular magnetic disk apparatus that satisfies the relationship of formula (1), data recorded on the medium is not erased by magnetization remaining on the main pole after recording operation.

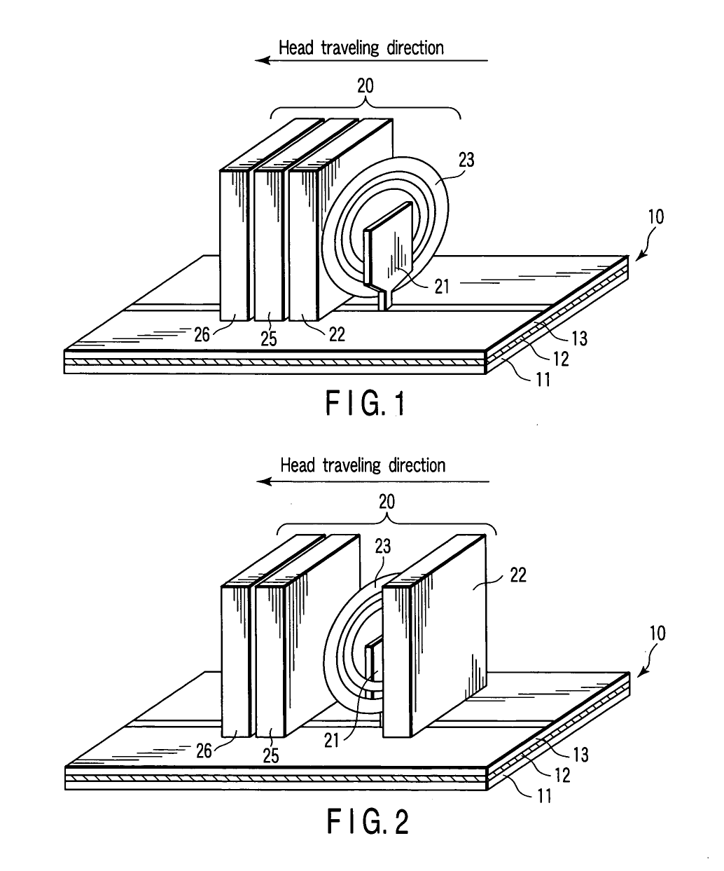

FIG. 1 is a perspective view of a perpendicular magnetic disk apparatus according to an embodiment of the present invention. A magnetic disk 10 shown in FIG. 1 includes a substrate 11, a soft underlayer 12 and a perpendicular recording layer 13 having magnetic anisotropy in the perpendicular direction to the film surface. Another layer such as a crystal orientation layer may be formed. Usually, a protective layer is formed on the perpendicular recording layer 13, and a lubricant is coated on the protective layer. A magnetic head 20 shown in FIG. 1 is a separate-type magnetic head in which a write head and a read head are separated. The write head includes a main pole 21, a return yoke 22 disposed on the leading side of the main pole 21, and an exciting coil 23. The main pole 21 is formed of a high-permeability material and generates a perpendicular magnetic field to the magnetic disk 10. A closed magnetic path is efficiently formed by the main pole 21, the soft underlayer 12 of magnetic disk 10, and the return yoke 22. The exciting coil 23 is wound around a back yoke that couples the main pole 21 and return yoke 22. The read head includes a magnetoresistive film (not shown in FIG. 1) and shield films 25 and 26 disposed on the trailing side and leading side of the magnetoresistive film.

FIG. 2 is a perspective view of a perpendicular magnetic disk apparatus according to another embodiment of the invention. This perpendicular magnetic disk apparatus has the same structure as the perpendicular magnetic disk apparatus shown in FIG. 1, except that the return yoke 22 is disposed on the trailing side of the main pole 21.

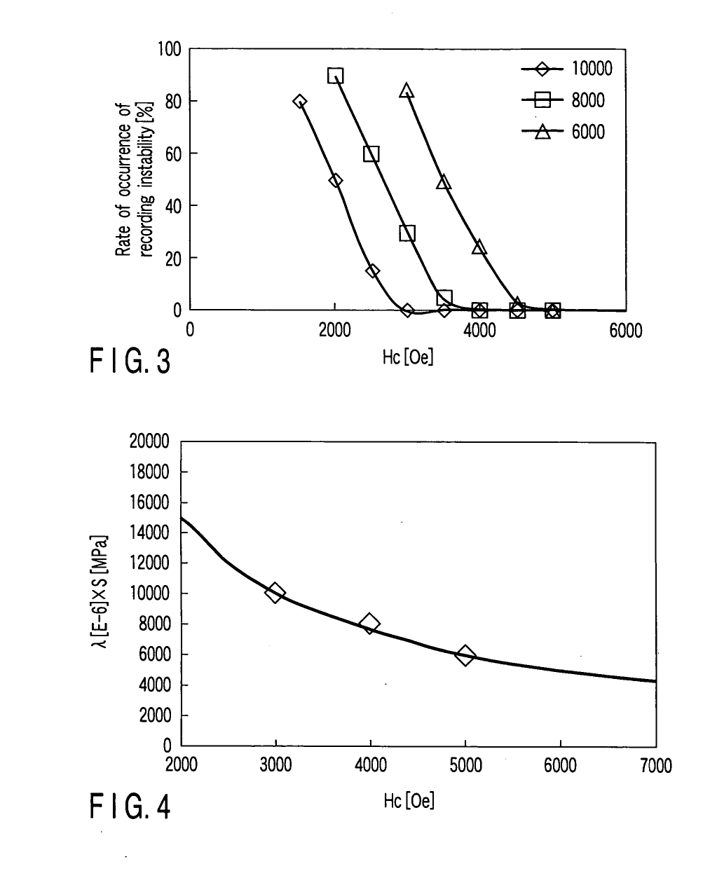

FIG. 3 shows the relationship between a coercivity Hc of the medium and an occurrence rate of recording instability when magnetic heads each including a main pole formed of different materials are used. The physical properties of the materials for the main poles are indicated by the product of the magnetostriction constant λ [E-6] of the main pole and the stress S [MPa] acting on the main pole, i.e., the magnetostrictive energy.

The occurrence of recording instability is defined by occurrence of output degradation of read signals for recorded data under a situation that no current is supplied to the write head. Specifically, the occurrence of recording instability is determined when a degradation of 5% or more is observed with respect to the initial output of the read signals for recorded data.

The occurrence rate of recording instability refers to a rate at which the recording instability occurs for a great number of write heads that are fabricated using a material with the same magnetostrictive energy. Usually, the occurrence rate is calculated on the basis of experimental results relating to several hundred to several thousand write heads.

It is found from FIG. 3 that the occurrence rate of recording instability becomes higher as the coercivity Hc decreases. In addition, it is found that the coercivity Hc of the medium, with which the occurrence rate of recording instability becomes zero, varies depending on the product of λ and S.

FIG. 4 shows lower-limit conditions under which the occurrence rate of recording instability becomes zero in the coordinate system of the coercivity Hc of the medium and the product of λ [E-6]×S [Mpa].

The curve in FIG. 4 is represented by the formula: λ×S=30,000,000/Hc. In a perpendicular magnetic disk apparatus that satisfies the condition above the curve, data recorded on the medium is not erased by magnetization remaining on the main pole after recording operation.

In order to reduce the recording instability, it is preferable that the value of magnetostrictive energy [λ×S] be high. However, if the product of λ and S is excessively high, physical breakage of the main pole may occur. Thus, the product of λ and S is set within a range in which no physical breakage of the main pole will occur.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A perpendicular magnetic disk apparatus comprising:
a perpendicular recording medium including a soft underlayer and a perpendicular recording layer; and
a write head including a main pole, a return yoke and an exciting coil,
wherein a product of a magnetostriction constant λ [E-6] of the main pole and a stress S [MPa] acting on the main pole, and a coercivity Hc [Oe] of the medium meet the following formula:
λ×S>30,000,000/Hc.

2. The apparatus according to claim 1, wherein the return yoke is disposed on a leading side of the main pole.

3. The apparatus according to claim 1, wherein the return yoke is disposed on a trailing side of the main pole.
